(19) United States
(12) Patent Application Publication
(10) Pub. No.: US 2011/0082572 A1
(43) Pub. Date: Apr. 7, 2011

(54) Distributing Media By Subscription

(76) Inventors: Thyagarajapuram S. Ramakrishnan, Saratoga, CA (US); Chintamani Patwardhan, Saratoga, CA (US)

(21) Appl. No.: 12/574,644

(22) Filed: Oct. 6, 2009

(51) Int. Cl. G06F 17/00; G06F 15/16

(52) U.S. Cl. 700/94; 709/203; 709/227

(57) ABSTRACT

A user can distribute media to subscribers through a media distribution service. The media distribution service can receive media from an author and distribute the media to one or more subscribers. Users can become a subscriber of the author (or media provider) and receive the author's uploaded media. To share media content, the media content is received by a server from a first remote device associated with an author. A subscriber associated with the author can be identified. A connection for audio content playback can be established between the server and a second remote device associated with the subscriber over which the media content is transmitted.

### BACKGROUND OF THE INVENTION

1. Field of the Invention

The present invention generally relates to audio communications and more particularly to communication of audio to a subscriber network.

2. Description of the Related Art

Modern technology allows for people to share audio content with others who are geographically separated. Voice messaging systems allow users to place a call and either converse with the recipient who answers the call or leave a message for the call recipient when the call is not answered. Cellular telecom companies can provide a notification to the voicemail recipient that a voicemail message is waiting for that user through the recipient's cellular phone.

Pod casts allow a pod caster to create an audio file. The audio file may consist of the pod caster discussing a particular subject and allow other users to download the file over a network. A user may access the pod cast audio file by downloading the entire file to a computer and then playing the audio file back with an audio player application.

Though systems exist for sharing audio content among users, the existing systems have problems. In particular, problems exist with these systems for effectively providing an audio file to multiple users while providing notification that the audio file is available.

### SUMMARY OF THE CLAIMED INVENTION

A user can distribute media to subscribers through a media distribution service. The media distribution service may be implemented by one or more servers in communication with communication systems, such as a telecom service system. The media distribution service can receive media from an author and distribute the media to one or more subscribers. Users can become a subscriber of the author (or media provider) and receive the author's uploaded media. The media can include audio, video and other media.

Sharing media content may include receiving audio content by a server from a first remote device associated with a first user. A subscriber associated with the first user can be identified. A connection for audio content playback can be established between the server and a second remote device associated with the subscriber.

Media content can also be shared by receiving media content by a server from a remote device associated with a first user. A subscriber associated with the first user can be identified. A connection can be established between the server and a mobile device associated with the subscriber. The connection can be used to access the media content at least in part over a telecommunications network. The media content can then be transmitted over the established connection.

In some embodiments, the media may include audio such as a voice message created by the media provider. The voice message can be uploaded to a media distribution server and transmitted to a subscriber which requests the voice message.

Embodiments of the method can be performed by a server in communication with a client or by the client itself. The method can also be performed by a processor executing a program contained on a computer readable storage medium.

### BRIEF DESCRIPTION OF THE DRAWINGS

FIG. 1 is an exemplary system for distributing media files.

FIG. 2 is a block diagram of an exemplary media distribution server.

FIG. 3 is an exemplary method for sharing media with a subscriber.

FIG. 4 is an exemplary method for receiving media.

FIG. 5 is an exemplary method for transmitting a notification.

FIG. 6 is an exemplary method for adding a user to a subscription list.

FIG. 7 is an exemplary method for managing billing of media distribution.

FIG. 8 is an exemplary computing system that may be used to implement an embodiment of the present invention.

### DETAILED DESCRIPTION

An author can distribute media to one or more subscribers through a media distribution service. The media distribution service may be implemented by one or more servers in communication with communication systems, such as a telecom service system. The media distribution service can receive media from the author having an account with the media distribution service and distribute the media to one or more subscribers who also have a media service account. Users can become a subscriber of the author and receive the author's uploaded media as a result of media requests or automatically provided notifications. The media can include audio, video and other media.

In some embodiments, media uploaded to the distribution service is not downloaded to a subscriber. Rather, the media may be provided as streaming content or over an established telecom connection such as a telephonic connection. In some embodiments, the media may include audio such as a voice message created by the media provider. The voice message can be uploaded to a media distribution server and transmitted to a subscriber which requests the voice message.

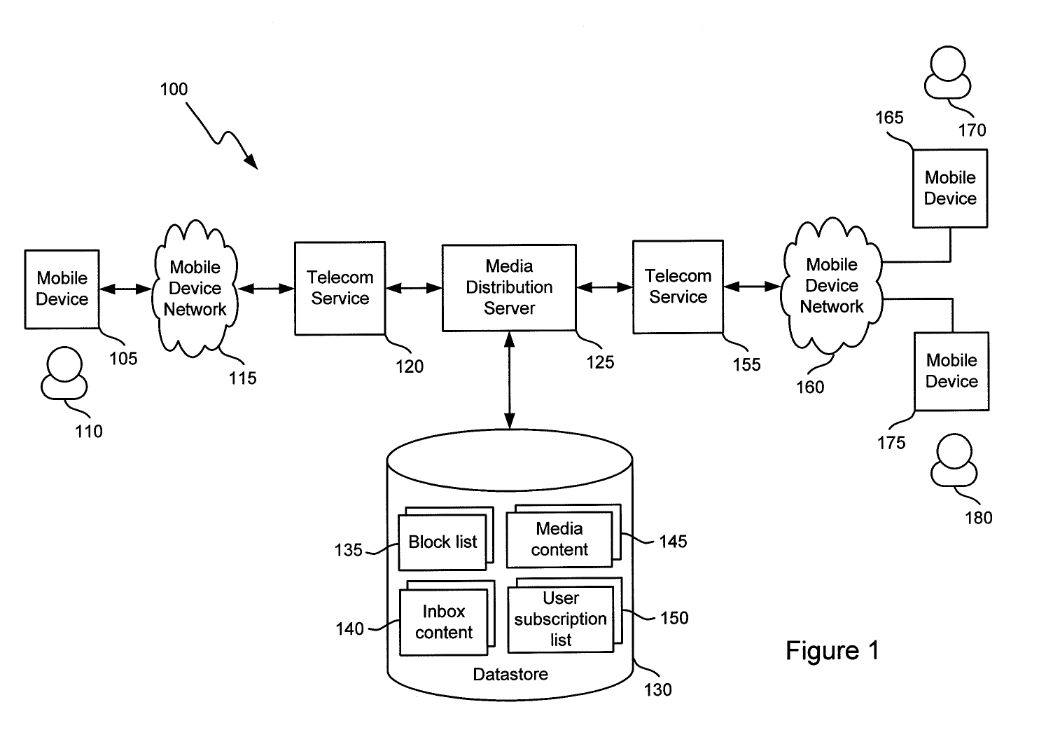

FIG. 1 is an exemplary system for distributing media files. The system of FIG. 1 includes mobile devices 105, 170 and 175, mobile device networks 115 and 160, telecom services 120 and 155, media distribution server 125, and data store 130. Mobile device 105 may be any computing device capable of connecting to mobile device network 115 and able to transmit audio, video, images, and other media over the network. In some embodiments, the audio may include a voice message created by an author 110 which uses mobile device 105. Mobile device 105 may be implemented as a cell phone, personal digital assistant (PDA), a smart phone, lap top computer, or other computing device.

Mobile device network 115 may facilitate communication between mobile device 105 and telecom service 120. The network 115 may be configured to communicate mobile device data, media data including audio data, and other data between mobile device 105 and telecom service 120. Network 115 may include a cell phone tower, relay, switch, server, and other equipment for communications between the mobile device and telecom service 120.

Telecom service 120 can be provided by a telecom company. Telecom service 120 can receive connection requests and other data from mobile device 105 (over mobile device network 115) and establish connections with a recipient of a communication request, such as media distribution center 125. Telecom service 120 may therefore act as a switch in establishing connections between a mobile device 105 and other devices. Telecom service 120 may be provided by telecom companies that provide a telecom service, such as Vodaphone in Egypt, KDDI in Japan, and Verizon in the United States.

Media distribution server 125 may include one or more servers that provide a media distribution service. Media distribution server 125 may receive connection requests and messages from telecom service 120, access data from data store 130, and relay information, data, media and other data to mobile devices 105, 165 and 175 through telecom service 155.

Data store 130 may include one or more servers or machines for storing data associated with a media distribution service. The data store may include a data layer including the stored data, an application layer for storing, accessing and processing the data, and an interface layer. Data store 130 and the data therein may be accessible by media distribution server 125. Data store 130 can be implemented locally within media distribution server 125, or remotely as illustrated in FIG. 1.

Data store 130 includes block list 135, inbox content 140, media content 145 and user subscription list 150, as well as user account data for author and subscriber users, user preferences, and other data. Block list 135 includes a list of subscribers that a particular author will not allow to subscriber to the author's media distribution account. Inbox content 140 may include media content associated with a user account and viewable through an interface provided by media distribution center. A user (i.e., a subscriber, an author, or other user of the media service) may access inbox content by performing a log-in or other authentication service to the service provided by media distribution server 125. Media content 145 may include media uploaded to the media distribution server by mobile device 105. The user subscription list includes a list of subscribers which subscribe to an author's media distribution account.

Telecom service 155 and mobile device network 160 may be implemented in a similar manner as telecom service 120 and mobile device 115, respectively, but by different providers.

Mobile device 165 and mobile device 175 may be associated with subscribers 170 and 180, respectively. The mobile devices may be used by subscribers 170 and 180 to access new media provided by a media provider 110 through a media distribution service.

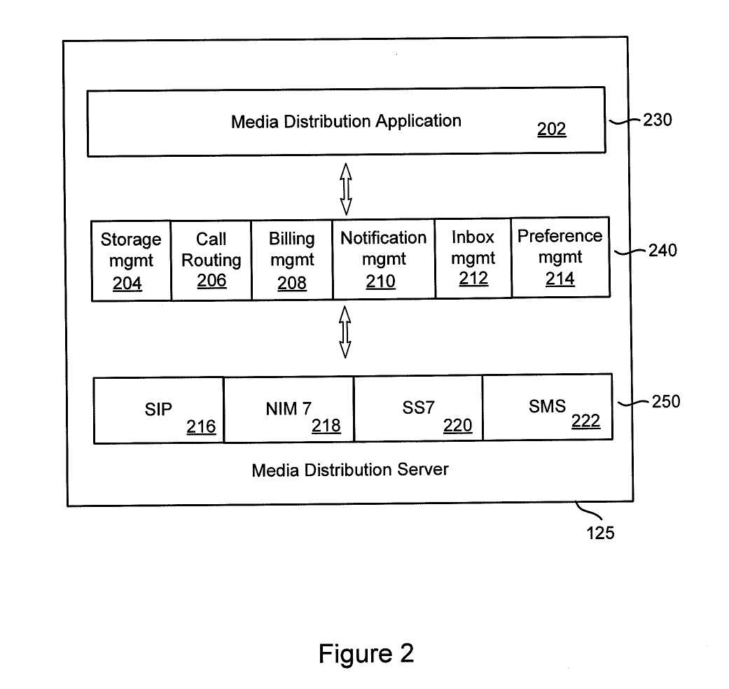

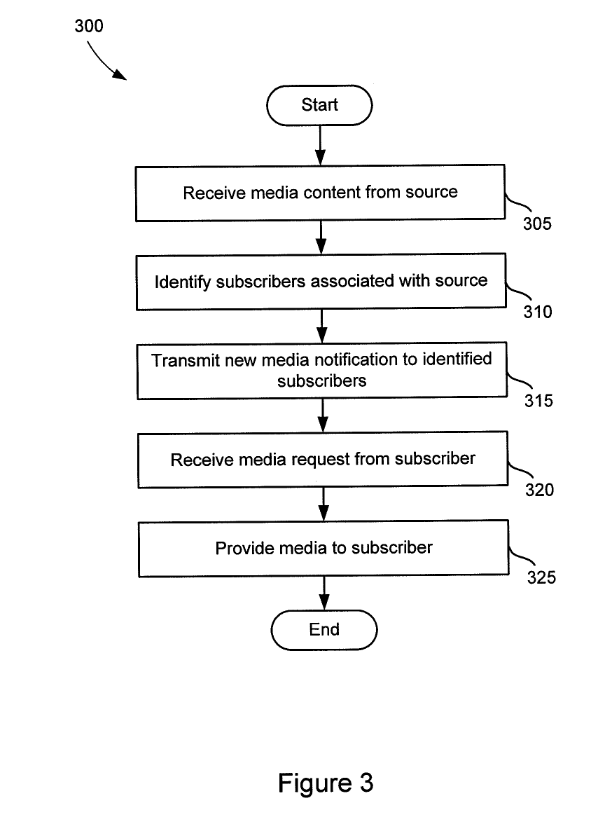

FIG. 2 is a block diagram of an exemplary media distribution server 125. The media distribution server includes an application layer 230, core service layer 240, and network interface layer 250. The application layer 230 includes media distribution application 202. Media distribution application 202 includes logic and business rules for implementing the media distribution service, including receiving and processing subscription requests, media uploads, media requests, and other operations. Exemplary media distribution service logic and business rules are discussed below with respect to FIGS. 3-7.

The core service layer 240 implements services for operating the media distribution service. These core services include storage management 204, call routing 206, billing management 208, notification management 210, inbox management 212 and preference management 214. Storage management 204 manages communications between data store 130, including storing data to and retrieving data from data store 130. Call routing 206 manages routing, connection and management of calls between telecom services 120 and 155. Billing management 208 manages the billing associated with uploaded media, media access, and other revenue aspects of the media distribution service. Notification management 210 manages generation of notifications and alerts to authors and subscribers, for example notifications that audio content is available for access or that audio content has been accessed. Inbox management 212 manages a user (subscriber, author, other user) inbox, including new, viewed, deleted and sent messages. Preferences management 214 manages the preferences of a user, including how the user prefers to receive a notification (e.g., cell phone, fax, email), how the user prefers to view their inbox, and other configurable preferences associated with the medial distribution service.

The network interface layer 250 enables media distribution server 125 to communicate with data store 130 and a variety of telecom services 120 and 155. The network interface layer 250 includes interfacing modules of SIP 216, NIM7 218, SS7 220, and SMS 222. NIM7 enables communication through an NIM7 device. SIP 216 enables communication through an SIP communications protocol that enables IP-based services. SS7 220 enables communication using protocols for the interpretation and use of an array of network control and operation signals according to the SS7 standard. SMS 222 enables a protocol for communicating short messages and allows the interchange of short text messages between mobile telephone devices.

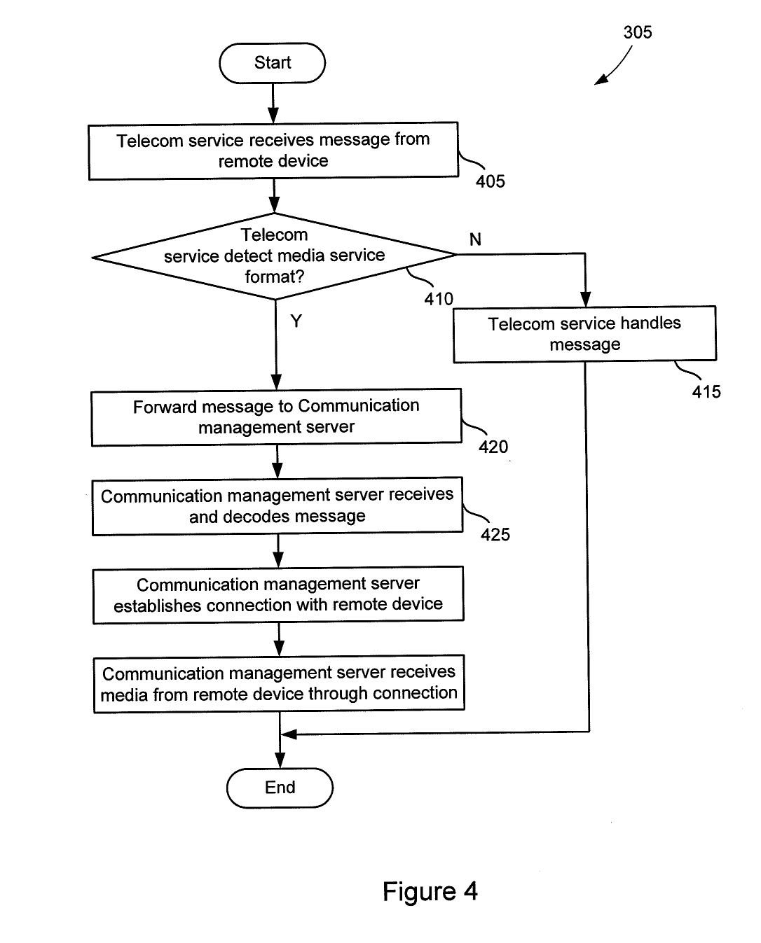

FIG. 3 is an exemplary method for distributing media to a subscriber. As illustrated in the method of FIG. 3, media content may be received from an author at step 305. The author can communicate via mobile device 105. Receiving the media content from the author may include the author providing an “upload media” code to mobile device 105 and transmitting the code from mobile device 1-5 to media distribution server 125, establishing a connection between author 110 at mobile device 105 and media distribution server 125, and receiving media over the established connection from mobile device 105. Receiving media content from a source is discussed in more detail below with respect to FIG. 4.

Subscribers 170-180 associated with the author are identified at step 310. Once media is received from an author, a query is made for a subscription list associated with the author. The query can be made by storage management 204 of media distribution application 202 to data store 130. The query may include a user (e.g., author) identifier for the user which provided the media. The data store 130 receives the query, retrieves the subscription list associated with the identified user, and transmits the subscription list to storage management module 204.

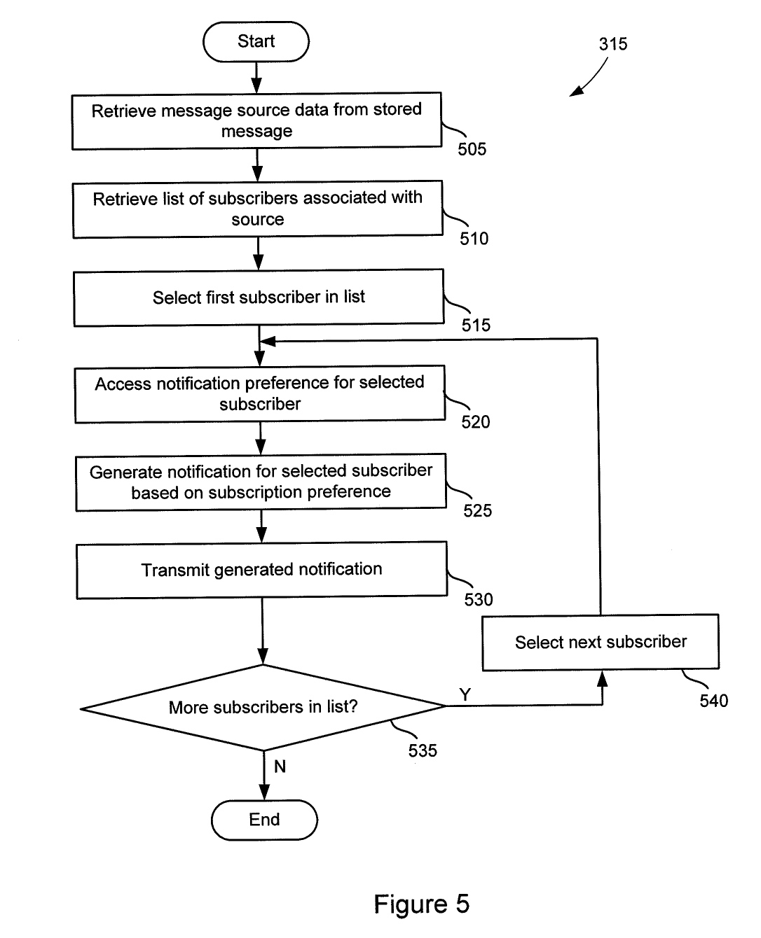

A new media notification is transmitted to the identified subscribers at step 315. The media notification may be transmitted to subscribers on the retrieved subscriber list. The transmission of the notification may comply with user preferences associated with each subscriber. Transmitting new media notifications is discussed in more detail below with respect to FIG. 5.

A media request is received from a subscriber at step 320. The request is initially received by telecom service 155. The telecom service 155 determines that the request is in a format associated with a distribution service and forwards the request to media distribution server 125. Media distribution server 125 receives and decodes the message to identify a command within the message. For example, the message may include a prefix to identify the message as a media distribution service message. The prefix may include, for example, an asterisk “*”.

Next, the media distribution server 125 may retrieve a code from the received message which identifies an action to perform, such as a character or string of characters that can be decoded identify an instruction to transmit media to a particular subscriber. Other examples of codes may include leaving a message for a subscription service user, uploading media to media distribution server 125, accessing an inbox, or performing another action.

Media can be provided to the subscriber at step 325. To provide the media, a subscriber preference is accessed to determine a format to provide media. The media is then transmitted to the subscriber based on the subscriber's preference. In some embodiments, the media may be streamed to the subscriber. In some embodiments, the media may be played over a telephone connection to the subscriber. In some embodiments, the media is not downloaded or otherwise physically provided as a file to the requesting subscriber. Providing media to the subscriber is discussed in more detail below with respect to the method of FIG. 5.

FIG. 4 is an exemplary method for receiving media by media distribution server 125. In some embodiments, the method of FIG. 4 provides more detail for step 305 of the method of FIG. 3. A telecom service 120 receives a message from a remote device 105 at step 405. The message may be an SMS message or in some other communication format. A determination is made as to whether the telecom service detects a media service format in the received message at step 410. The media service format may be detected by media distribution application 202 based on a prefix or some other identifier in the message to signal that the message is intended for media distribution server 125. The prefix or other identifier may include an asterisk “*”, a character or string, or some other identifier. If the telecom service 120 detects that the message has a media service format, the message is forwarded to media distribution server 125 by telecom service 120 at step 420. If the telecom service 120 detects that the message is not in the media service format, the telecom service 120 handles the message at step 415 and the method at FIG. 4 ends.

After forwarding the message to media distribution server 125, server 125 receives and decodes the message at step 425. The decoding of the message may include identifying a service prefix, an action code, and a user code within the message. The action code may indicate that a message should be placed in an inbox of another user, stored for distribution to subscribers, that a media is being requested, or some other action. The user code may identify a specific user (i.e., subscriber, author) from which to retrieve a subscription message, leave a message, or perform some other action.

The media distribution server 125 establishes a connection with a remote device 170 at step 430. In some embodiments, upon establishing the connection, media distribution server 125 sends a welcome message to mobile device 105 as well as a prompt to perform the action requested in the received message. For example, the message may prompt author 110 to select media to upload or provide audio media. After establishing the connection, media distribution server 125 may receive the media from the remote device through the connection at step 435. Receiving the media involves the author initializing the transmittal of the media at mobile device 105. The media is transmitted over mobile device network 115 to telecom service 120. Telecom service 120 then provides the media to the interfaces layer of media distribution server 125.

FIG. 5 is an exemplary method for transmitting a notification. In some embodiments, the method of FIG. 5 provides more detail for step 315 of the method of FIG. 3. First, media distribution server 125 accesses subscribers associated with an author at step 505. A first subscriber in the list is selected at step 510. A notification preference for the selected subscriber is then accessed at step 515. The notification preference may be a user preference retrieved from data store 130 by the preference manager of media distribution application 202 on server 125. Preferences may include a language in which to provide the notification, a font, a communication means, and other formatting for the notification. A notification is then generated for the selected subscriber based on the subscription preference at step 520. The notification may be an audio notification, text notification, video notification or in some other format.

The generated notification is then transmitted to the selected subscriber at step 525. For example, the notification may be transmitted to subscriber 170 at mobile device 165. The determination is then made as to whether more subscribers are in the accessed subscriber list at step 530. If no further subscribers are in the list, the method of FIG. 5 ends. If additional subscribers are contained in the list, the next subscriber is selected at step 535 and the method of FIG. 5 returns to step 530.

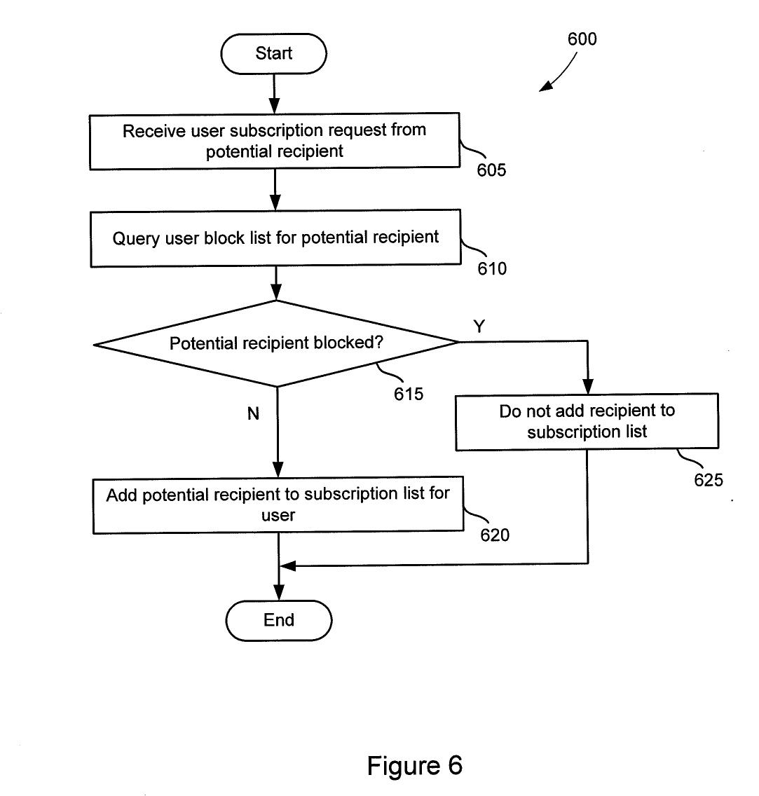

Users of a media distribution service may want to become a subscriber of an author's account. The author may not want to allow just any user to become a subscriber, however. FIG. 6 is an exemplary method for adding a user to a subscription list. A user subscription request is received from a potential recipient or subscriber at step 605. A block list is then queried for the author account for which the potential subscriber wishes to subscribe at step 610. The author's block list 135 may be stored in the data store 130 and retrieved by storage management module 204. A determination is then made as to whether the potential recipient should be blocked at step 615. If the potential recipient is listed in the author's block list, then the recipient should be blocked from becoming a subscriber of the author and is not added to the author's subscription list at step 625. If the recipient should not be blocked, the potential recipient is added to the subscription list for the author at step 620.

In some embodiments, the billing for a media distribution service can be applied based on how activity associated with one or more accounts. For example, if an author uploads an audio file that is viewed by one or two subscribers or other users, the service may charge the author for the upload while the subscribers and other users access the audio file free of charge. If an author uploads an audio file that is viewed by a larger number of users, the service may charge each user which accesses the audio file. Different billing options can be applied to media experiencing different levels of interest.

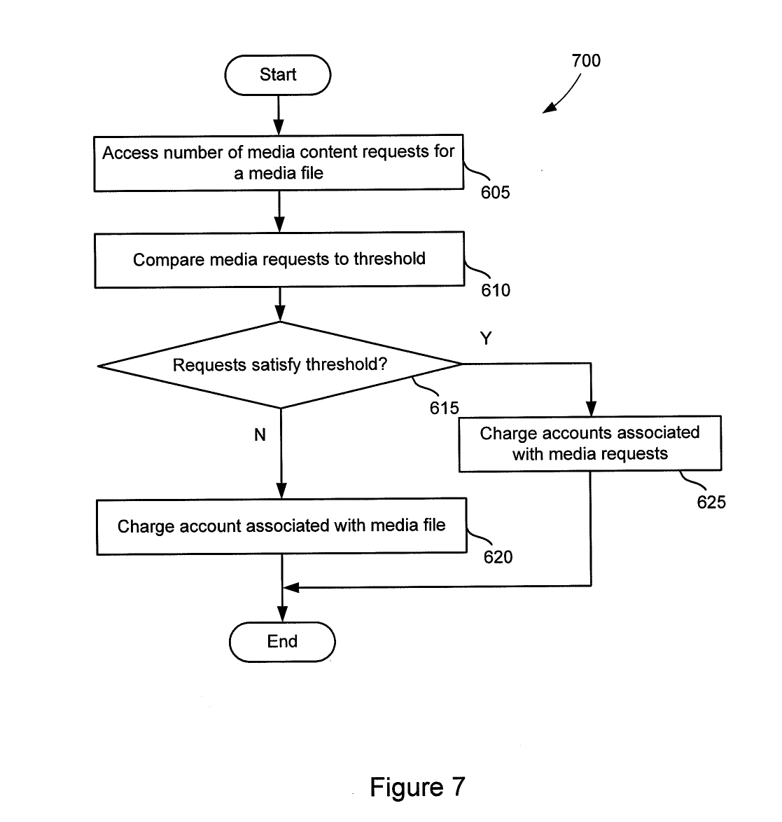

FIG. 7 is an exemplary method for managing billing of media distribution. The number of media content requests is accessed for a particular media file at step 605. In some embodiments, the media distribution server 125 tracks or logs the number of requests for loaded media content. This number of media access requests is accessed at step 605. The media requests are compared to a threshold at step 610. A determination is then made as to whether the number of media requests satisfies the threshold at step 615. If the number of media requests does not satisfy the threshold, for example is not as high as the threshold, the media provider account for the user who uploads the media is charged a fee for the media file at step 620. For example, if the threshold for billing was currently fifty user access requests and a media file uploaded by an author was associated with sixty access requests, then enough subscribers requested access to the media to justify charging the subscribers. If at step 615 the determination is made that the number of requests does satisfy the threshold, then the accounts associated with the media request are charged a fee at step 625.

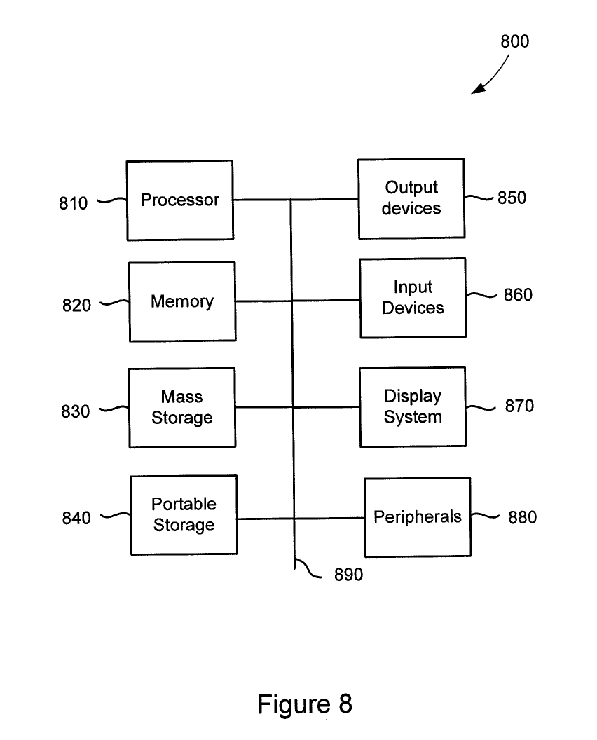

FIG. 8 is a block diagram of an exemplary computing device. In some embodiments, the exemplary computing device of FIG. 8 may be used to implement mobile device 105, telecom service 120, media distribution server 125, telecom service 155, and data store 130.

FIG. 8 illustrates an exemplary computing system 800 that may be used to implement an embodiment of the present invention. The computing system 800 of FIG. 8 includes one or more processors 810 and memory 810. Main memory 810 stores, in part, instructions and data for execution by processor 810. Main memory 810 can store the executable code when in operation. The system 800 of FIG. 8 further includes a mass storage device 830, portable storage medium drive(s) 840, output devices 850, user input devices 860, a graphics display 870, and peripheral devices 880.

The components shown in FIG. 8 are depicted as being connected via a single bus 890. The components may be connected through one or more data transport means. Processor unit 810 and main memory 810 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive or an optical disk drive, is a non-volatile storage device for storing data and instructions for use by processor unit 810. Mass storage device 830 can store the system software for implementing embodiments of the present invention for purposes of loading that software into main memory 810.

Portable storage device 840 operates in conjunction with a portable non-volatile storage medium, such as a floppy disk, compact disk or Digital video disc, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, or a pointing device, such as a mouse, a trackball, stylus, or cursor direction keys. Additionally, the system 800 as shown in FIG. 8 includes output devices 850. Suitable output devices include speakers, printers, network interfaces, and monitors.

Display system 870 may include a liquid crystal display (LCD) or other suitable display device. Display system 870 receives textual and graphical information, and processes the information for output to the display device.

Peripherals 880 may include any type of computer support device to add additional functionality to the computer system. Peripheral device(s) 880 may include a modem or a router.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for sharing media with one or more users, comprising:
receiving audio content by a server from a first remote device associated with a first user;
identifying a subscriber associated with the first user; and
establishing a connection for playback of the audio content between the server and a second remote device associated with the subscriber.

2. The method of claim 1, further comprising receiving a code associated with a media service format.

3. The method of claim 1, further comprising:
receiving a code associated with a media upload; and
establishing a connection with the first remote device in response to receiving the code.

4. The method of claim 1, wherein the audio content is received by the server from a machine associated with a telecom service

5. The method of claim 1, the method further comprising determining a first user identifier for the first user from data received with the audio content.

6. The method of claim 5, the method further comprising retrieving a subscriber list associated with the first user identifier.

7. The method of claim 1, the method further comprising sending the second remote device a notification associated with the audio content.

8. The method of claim 8, the method further comprising creating the notification based on a preference associated with the subscriber.

9. The method of claim 1, further comprising:
receiving a request from the subscriber associated with the audio content; and
playing the media content to the subscriber through the established connection.

10. A computer readable storage medium having embodied thereon a program, the program being executable by a processor to perform a method for sharing media, the method comprising:
receiving audio content by a server from a first remote device associated with a first user;
identifying a subscriber associated with the first user; and
establishing a connection for playback of the audio content between the server and a second remote device associated with the subscriber.

11. The computer readable storage medium of claim 10, the method further comprising receiving a code associated with a media service format.

12. The computer readable storage medium of claim 10, the method further comprising:
receiving a code associated with a media upload; and
establishing a connection with the first remote device.

13. The computer readable storage medium of claim 10, the method further comprising determining a first user identifier for the first user from data received with the audio content.

14. The computer readable storage medium of claim 10, the method further comprising retrieving a subscriber list associated with the first user identifier.

15. The computer readable storage medium of claim 10, the method further comprising sending the second remote device a notification associated with the audio content.

16. The computer readable storage medium of claim 10, the method further comprising:
receiving a request from the subscriber associated with the audio content; and
playing the media content to the subscriber through the established connection.

17. A method for sharing media with one or more users, comprising:
receiving media content by a server from a remote device associated with a first user;
identifying a subscriber associated with the first user;
establishing a connection for access to the media content between the server and a mobile device associated with the subscriber, the connection established at least in part over a telecommunications network; and
transmitting the media content over the established connection.

18. The method of claim 17, further comprising transmitting a notification from a server to a subscriber associated with the first user, the notification associated with the received audio content.

19. The method of claim 17, further comprising receiving an access request from the subscriber, the connection established in response to receiving the access request.

20. The method of claim 17, further comprising:
receiving an author identifier with the media content, the first user comprising the author; and
retrieving a subscription list associated with author identifier, the subscription list including the subscriber,
the media content transmitted over the established connection to the subscriber.
